(19) United States
(12) Patent Application Publication
(10) Pub. No.: US 2024/0114272 A1
(43) Pub. Date: Apr. 4, 2024

(54) SPEAKER DEVICE

(71) Applicant: Acer Incorporated, New Taipei City (TW)

(72) Inventors: Jia-Ren CHANG, New Taipei City (TW); Ruey-Ching SHYU, New Taipei City (TW); Chien-Chung CHEN, New Taipei City (TW)

(21) Appl. No.: 18/302,188

(22) Filed: Apr. 18, 2023

(30) Foreign Application Priority Data
Sep. 28, 2022 (TW) 111136665

(51) Int. Cl. H04R 1/02; H04R 1/28

(52) U.S. Cl. CPC H04R 1/025; H04R 1/2823; H04R 2499/11

(57) ABSTRACT

A speaker device is installed in an electronic device, and the speaker device includes a speaker module and a first loop tube. The speaker module has a casing and a speaker unit. The casing has a main sound cavity and a sound outlet. The speaker unit is disposed in the casing, and the speaker unit includes a diaphragm, which is communicated with the sound outlet. The first loop tube has a first end and a second end, and the first end is connected to the casing. The length of the first loop tube is at least 10 mm, and the inner diameter of the first loop tube is at least 2 mm.

### CROSS REFERENCE TO RELATED APPLICATIONS

This application claims the benefit of Taiwan Patent Application No. 111136665, filed Sep. 28, 2022, the entirety of which are incorporated by reference herein.

### BACKGROUND OF THE INVENTION

### Field of the Disclosure

The present disclosure relates to a speaker device, and in particular it relates to a speaker device capable of increasing the sound pressure level at low frequencies.

### Description of the Related Art

As technology has developed, many of today's electronic devices (such as notebook computers) are quite popular products nowadays. These notebook computers are the most popular and widespread of today's consumer products. Users can execute various applications on notebook computers to achieve various purposes, such as watching videos, playing games, browsing the web, and reading e-books.

Generally speaking, electronic devices such as notebook computers are equipped with at least one speaker device configured to provide sound, including music. However, the design trends in the manufacturing of notebook computers shows that each successive generation of these products is becoming thinner and lighter, meaning that the size of the speaker—as well as of the sound cavity inside the speaker—must also be reduced. A sound cavity of insufficient volume will cause the speaker to produce sound that is of insufficient quality to meet the user's needs, especially with low-frequency sound effects.

Therefore, how to design a speaker device that can improve the low-frequency effect is a topic nowadays that needs to be discussed.

### BRIEF SUMMARY OF THE INVENTION

Accordingly, one objective of the present disclosure is to provide a speaker device to solve the above problems.

The present disclosure provides a speaker device which is installed in an electronic device, and the speaker device includes a speaker module and a first loop tube. The speaker module has a casing and a speaker unit. The casing has a main sound cavity and a sound outlet. The speaker unit is disposed in the casing, and the speaker unit includes a diaphragm, which is communicated with the sound outlet. The first loop tube has a first end and a second end, and the first end is connected to the casing. The length of the first loop tube is at least 10 mm, and the inner diameter of the first loop tube is at least 2 mm.

According to some embodiments, the first end has a first opening which is communicated with the main sound cavity, and the second end has a second opening which is communicated with an accommodating space of the electronic device.

According to some embodiments, the casing has a rectangular structure, and the first loop tube has a first segment and a second segment. The first end and the second end are respectively located in the first segment and the second segment, the first segment is parallel to and adjacent to a first side surface of the rectangular structure, and the second segment is parallel to and adjacent to a second side surface of the rectangular structure.

According to some embodiments, the speaker device further includes an adjusting unit disposed in the first loop tube, and the adjusting unit is disposed adjacent to the second opening.

According to some embodiments, the distance between the adjusting unit and the second opening is ten to twenty percent of the total length of the first loop tube.

According to some embodiments, the adjustment unit is made of PU foam, PE foam, special rubber foam, melamine cotton, glass fiber cotton, rock wool, OFAN polyester fiber sound-absorbing cotton, melamine sound-absorbing cotton, activated carbon, or a combination thereof.

According to some embodiments, the first loop tube is a tubular structure, the adjusting unit is a cylindrical structure, and the adjusting unit conforms to the first loop tube.

According to some embodiments, the first loop tube is a rectangular tubular structure, the adjusting unit is correspondingly a rectangular columnar structure, and the cross-sections of the first loop tube and the adjusting unit are rectangles.

According to some embodiments, the speaker device further includes a first expansion unit corresponding to the shape of at least one internal component of the electronic device, the second end of the first loop tube is connected to the first expansion unit, and a first secondary sound cavity formed by the first expansion unit is communicated with the first loop tube and the main sound cavity via the second end.

According to some embodiments, the first expansion unit is made of metal.

According to some embodiments, the first secondary sound cavity is filled with a porous material which includes zeolite powder, activated carbon, or both.

According to some embodiments, the connecting junction of the first end and the casing is sealed by a sealing element, and the connecting junction of the second end and the first expansion unit is sealed by another sealing element. The sealing elements include silicone or a sealing ring.

According to some embodiments, the first expansion unit is a recyclable and inflatable bag.

According to some embodiments, the speaker device further includes a second loop tube and a second expansion unit, the second loop tube is connected between the first expansion unit and the second expansion unit, so that a second secondary sound cavity formed by the second expansion unit is communicated with the first secondary sound cavity and the main sound cavity via the second loop tube.

According to some embodiments, the connecting junction of the second loop tube and the second expansion unit, and the connecting junction of the second loop tube and the first expansion unit are sealed by two sealing elements.

The present disclosure provides a speaker device, including a speaker module and a first loop tube. The first end of the first loop tube is connected to the casing of the speaker module, the second end of the first loop tube is an unclosed free end which has a second opening, so that the main sound cavity formed by the casing is communicated with the outside air. Based on this design, the low-frequency sound output effect of the speaker device can be effectively improved.

In addition, in some embodiments, the speaker device may further include at least one expansion unit connected to the speaker module through at least one loop tube. Because the secondary sound cavity formed by the expansion unit and the main sound cavity of the speaker module can jointly form a larger sound cavity, the low-frequency sound output effect of the speaker device can be further improved.

Moreover, in some embodiments, an adjusting unit can be disposed in the loop tube, and/or the expansion unit can be filled with porous material. Such design will reduce the moving speed of air molecules, so that the resonance frequency decreases correspondingly, thereby increasing the sound pressure level at low frequencies.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a partial structure of an electronic device 10 according to an embodiment of the present disclosure.

FIG. 2 is a perspective view of the speaker device 50L according to an embodiment of the present disclosure.

FIG. 3 is a schematic diagram of a partial structure of an electronic device 10 according to another embodiment of the present disclosure.

FIG. 4 is a schematic diagram of the speaker device 50L according to another embodiment of the present disclosure.

FIG. 5 is a chart illustrating the relationship between frequency and sound pressure level of the speaker devices of different embodiments of the present disclosure and a conventional speaker device.

FIG. 6 is a chart illustrating the relationship between frequency and impedance of the speaker devices of different embodiments of the present disclosure and the conventional speaker device.

FIG. 7 is a chart illustrating the relationship between frequency and sound pressure level of the speaker device of another embodiment of the present disclosure and the conventional speaker device.

FIG. 8 is a chart illustrating the relationship between frequency and impedance of the speaker device of another embodiment of the present disclosure and the conventional speaker device.

FIG. 9 is a schematic diagram of a partial structure of an electronic device 10 according to another embodiment of the present disclosure.

FIG. 10 is a schematic diagram of the speaker device 50L according to another embodiment of the present disclosure.

### DETAILED DESCRIPTION OF THE INVENTION

In the following detailed description, for the purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept can be embodied in various forms without being limited to those exemplary embodiments. In addition, the drawings of different embodiments can use like and/or corresponding numerals to denote like and/or corresponding elements in order to clearly describe the present disclosure. However, the use of like and/or corresponding numerals in the drawings of different embodiments does not suggest any correlation between different embodiments. The directional terms, such as “up”, “down”, “left”, “right”, “front” or “rear”, are reference directions for accompanying drawings. Therefore, using the directional terms is for description instead of limiting the disclosure.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

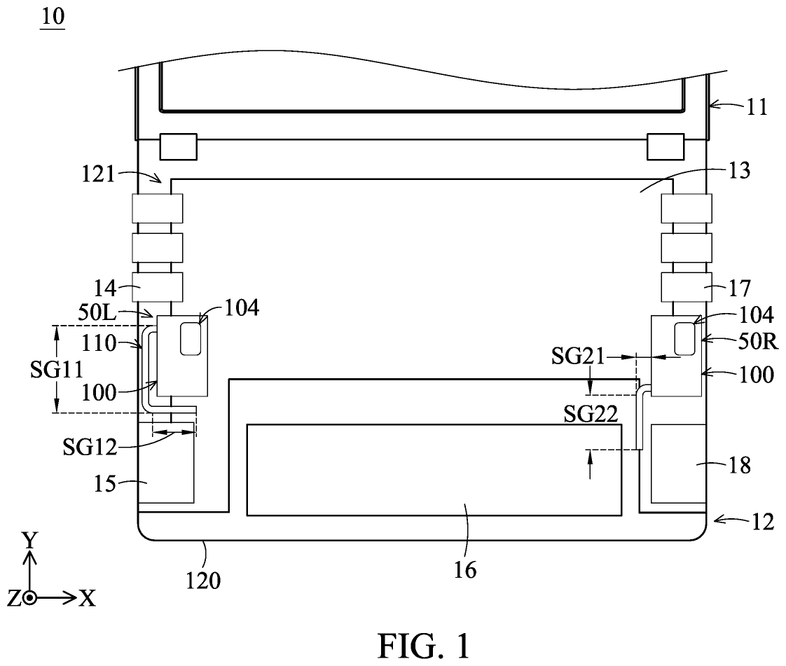

Please refer to FIG. 1, which is a schematic diagram of a partial structure of an electronic device 10 according to an embodiment of the present disclosure. The electronic device 10 can be a notebook computer with a display module 11 and a host module 12. The host module 12 is connected to the display module 11, and the host module 12 may include a motherboard 13, a first electronic component 14, a second electronic component 15, a third electronic component 16, a fourth electronic component 17 and a fifth electronic component 18. It should be noted that, in order to clearly show the internal structure of the host module 12, the upper casing of the host module 12 (generally referred to as the C part) is omitted herein.

The first electronic component 14 is, for example, an image output connector, the second electronic component 15 is, for example, a network connector, the third electronic component 16 is, for example, a battery, the fourth electronic component 17 is, for example, a USB connector, and the fifth electronic component 18 is, for example, an expansion port, but they are not limited thereto. The motherboard 13 and the above electronic components are accommodated in an accommodating space 121 of the host module 12.

Furthermore, the electronic device 10 may further include two speaker devices 50L and 50R, which are disposed on the motherboard 13. The speaker device 50L is disposed between the first electronic component 14 and the second electronic component 15, and the speaker device 50R is disposed between the fourth electronic component 17 and the fifth electronic component 18.

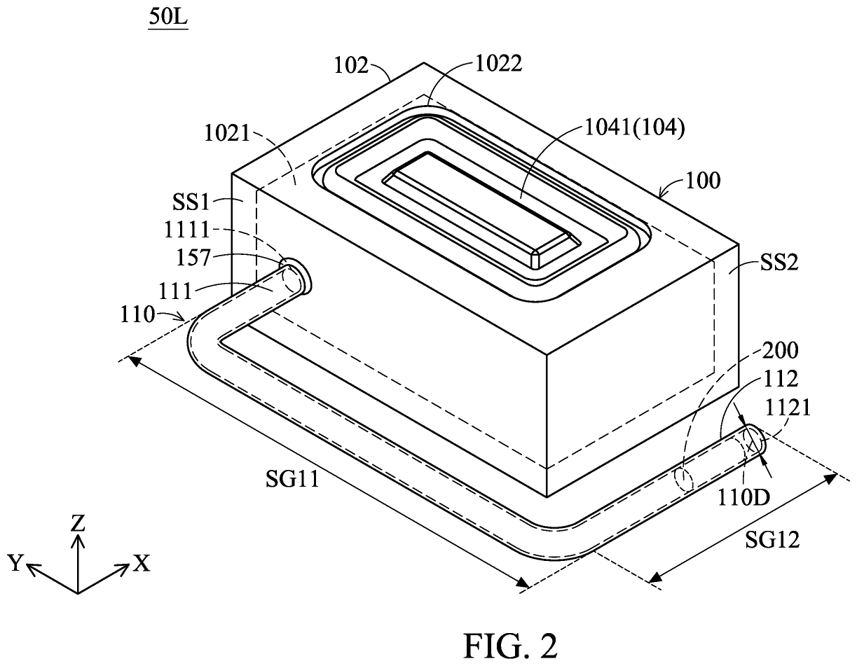

Next, please refer to FIG. 1 and FIG. 2. FIG. 2 is a perspective view of the speaker device 50L according to an embodiment of the present disclosure. In this embodiment, the speaker device 50L includes a speaker module 100 and a first loop tube 110, and the speaker module 100 has a casing 102 and a speaker unit 104.

The casing 102 has a main sound cavity 1021 and a sound outlet 1022, and the speaker unit 104 is disposed in the casing 102 and is communicated with the main sound cavity 1021. The speaker unit 104 includes a diaphragm 1041, and the diaphragm 1041 is communicated with the sound outlet 1022. The speaker unit 100 can further include a coil and a magnet (not shown in the figures), and the coil can be connected to the diaphragm 1041. When the coil is energized, it can act with the magnet to generate electromagnetic driving force to drive the diaphragm 1041 to move, so that the current signal can be converted into the sound signal.

The first loop tube 110 can be made of a soft material. For example, the first loop tube 110 can be made of soft plastic material, but it is not limited thereto. Furthermore, the total length of the first loop tube 110 is at least 10 mm, and the internal diameter 110D of the first loop tube 110 is at least 2 mm.

In this embodiment, the first loop tube 110 may have a first end 111 and a second end 112. The first end 111 is connected to the casing 102, and the first end 111 has a first opening 1111, which is communicated with the main sound cavity 1021. The second end 112 has a second opening 1121, which is communicated with the accommodating space 121 of the electronic device 10. That is, the second end 112 is an unclosed free end.

In this embodiment, the casing 102 has a rectangular structure, and the first loop tube 110 can be bent into a first segment SG11 and a second segment SG12. As shown in FIG. 2, the first end 111 and the second end 112 are respectively located in the first segment SG11 and the second segment SG12.

As shown in FIG. 1, because the gap between the speaker device 50L and the outer casing 120 of the host module 12 is narrow, and the gap between the speaker device 50L and the second electronic component 15 is narrow, the first segment SG11 can be configured to be parallel to and adjacent to a first side surface SS1 of the rectangular structure, and the second segment SG12 may be configured to be parallel to and adjacent to a second side surface SS2 of the rectangular structure.

In this embodiment, the speaker device 50L may further include an adjusting unit 200 disposed in the first loop tube 110, and the adjusting unit 200 is disposed adjacent to the second opening 1121.

For example, the distance between the adjusting unit 200 and the second opening 1121 may be ten to twenty percent of the total length of the first loop tube 110. In this embodiment, the distance between the adjusting unit 200 and the second opening 1121 is 1 to 2 mm, but it is not limited thereto.

In some embodiments, the adjusting unit 200 is made of a material with sound-absorbing properties. For example, the adjustment unit 200 is made of PU foam, PE foam, special rubber foam, melamine cotton, glass fiber cotton, rock wool, OFAN polyester fiber sound-absorbing cotton, melamine sound-absorbing cotton, activated carbon, or a combination thereof.

In this embodiment, the first loop tube 110 is a tubular structure, and the adjusting unit 200 is a cylindrical structure. The adjusting unit 200 conforms to the first loop tube 110, which means that the diameter of the adjusting unit 200 is substantially equal to the internal diameter 110D of the first loop tube 110.

The cross-sectional shapes of the first loop tube 110 and the adjusting unit 200 of the present disclosure are not limited to circular shapes. For example, in other embodiments, the first loop tube 110 can be a rectangular tubular structure, the adjusting unit 200 is correspondingly a rectangular columnar structure, and the cross-sections of them are rectangles.

It should be noted that, in this embodiment, the speaker module 100 of the speaker device 50R has the same structure as the speaker module 100 of the speaker device 50L, so the speaker module 100 of the speaker device 50R will not be repeated herein. However, as shown in FIG. 1, because the surrounding space of the speaker device 50R is different from the surrounding space of the speaker device 50L, the arrangement of the first loop tube 110 in the speaker device 50R is also different.

For example, in order to correspond to the shape of the gap between the third electronic component 16 and the fifth electronic component 18, the length of the first segment SG21 of the speaker device 50R is smaller than the length of the first segment SG11 of the speaker device 50L, and the length of the second segment SG22 of the speaker device 50R is greater than the length of the second segment SG12 of the speaker device 50L. In addition, the length of the first segment SG21 of the first loop tube 110 of the speaker device 50R is smaller than the length of the second segment SG22.

Based on the design of the first loop tube 110 and the adjusting unit 200 of this embodiment, the bass effect of the original speaker module 100 can be significantly enhanced. Specifically, please refer to the Helmholtz formula listed below:

$$f = \frac{C}{2 π} \sqrt{\frac{S}{VL}}$$

C is the sound velocity, S is the cross-sectional area of the first loop tube 110, V is the volume of the sound cavity (such as the main sound cavity 1021), and L is the length of the first loop tube 110.

As shown in this formula, when L becomes longer, the resonance frequency f will decrease. Because the main sound cavity 1021 of this embodiment is communicated with the first loop tube 110, which means that the L in the formula increases, the output effect in the low frequency can be enhanced. In addition, when C decreases, the resonance frequency f also decreases. Specifically, the adjusting unit 200 reduces the sound velocity in the first loop tube 110, so that the output effect in the low frequency can be further enhanced.

In addition, because the first loop tube 110 is made of a soft material, its bending method can be adjusted according to the configuration in the host module 12. Based on the above design, it can not only enhance the output effect in the low frequency, but also achieve the purpose of overall thinning of the electronic device.

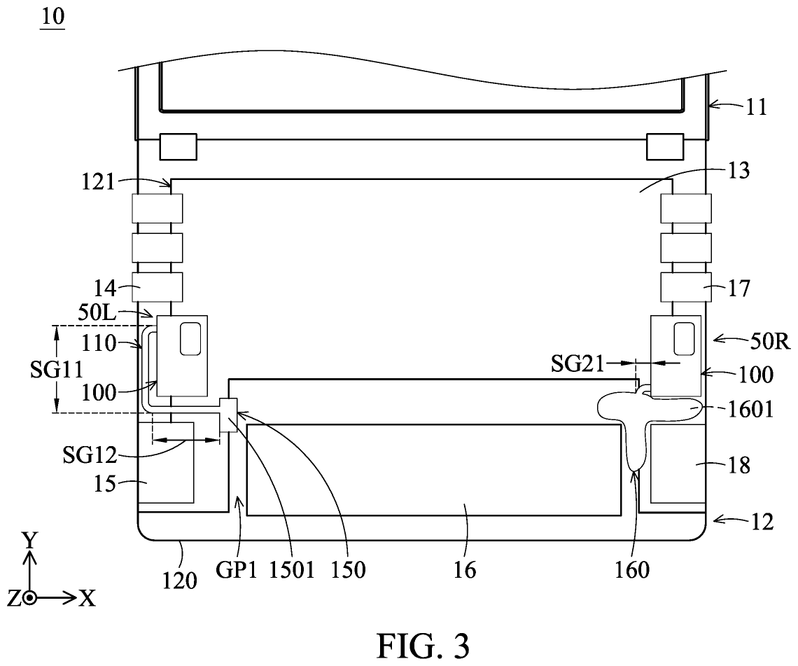

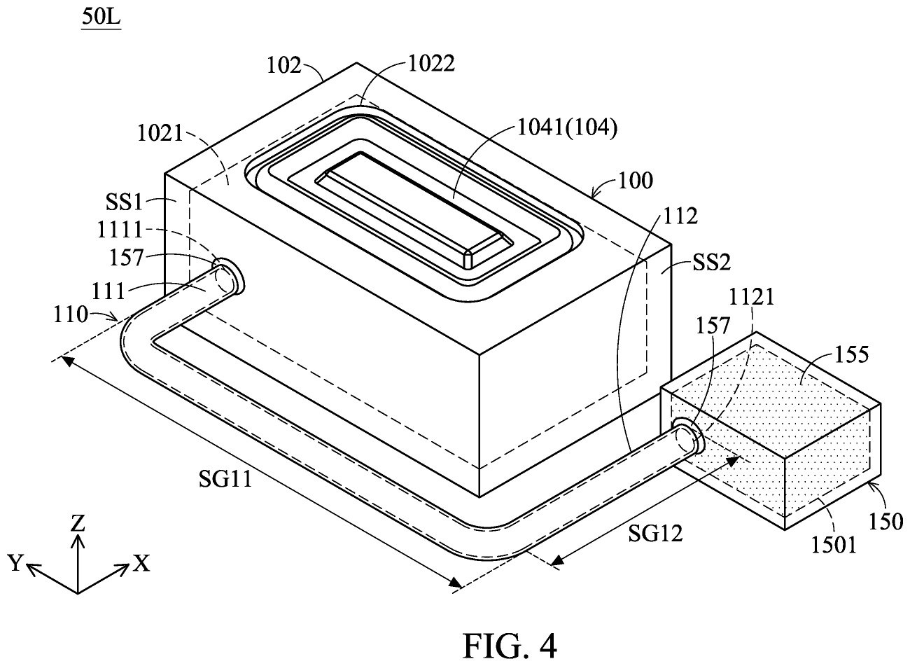

Next, please refer to FIG. 3 and FIG. 4. FIG. 3 is a schematic diagram of a partial structure of an electronic device 10 according to another embodiment of the present disclosure, and FIG. 4 is a schematic diagram of the speaker device 50L according to another embodiment of the present disclosure. In this embodiment, the speaker device 50L further includes a first expansion unit 150 corresponding to the shape of at least one internal component of the electronic device 10, and the second end 112 of the first loop tube 110 is connected to the first expansion unit 150.

Specifically, as shown in FIG. 3, in order to correspond to the shapes of the second electronic component 15 and the third electronic component 16, when viewed along the Z-axis, the first expansion unit 150 may be a rectangle, and the width of the first expansion unit 150 along the X-axis is smaller than a gap GP1 between the second electronic component 15 and the third electronic component 16.

Furthermore, as shown in FIG. 4, the first expansion unit 150 can form a closed first secondary sound cavity 1501, which is communicated with the first loop tube 110 and the main sound cavity 1021 via the second opening 1121 of the second end 112. Therefore, the first secondary sound cavity 1501 and the main sound cavity 1021 can jointly form a larger sound cavity, thereby improving the low-frequency sound output effect of the speaker device 50L.

In this embodiment, the first expansion unit 150 is made of metal. For example, the first expansion unit 150 can be made of copper, iron or stainless steel. Based on this design, the low-frequency sound output effect of the speaker device 50L can be further improved.

In addition, in some embodiments, the first secondary sound cavity 1501 may be filled with a porous material 155. The porous material 155 can be, for example, zeolite powder, activated carbon, or both. After the porous material 155 is filled in the first secondary sound cavity 1501, the moving speed of the air molecules in the first secondary sound cavity 1501 will decrease, which means that the sound velocity in the Helmholtz formula will decrease. Thus, the resonance frequency is decreased, thereby increasing the sound pressure level (SPL) at low frequencies.

It is worth noting that in the present disclosure, in order to ensure airtightness, the connecting junction of the first end 111 and the casing 102 is sealed by a sealing element 157. The sealing element 157 can be made of silicone, but it is not limited thereto.

For example, the sealing element 157 can also be a sealing ring. Similarly, the connecting junction of the second end 112 and the first expansion unit 150 can also be sealed by another sealing element 157.

In addition, as shown in FIG. 3, different from the first expansion unit 150, the first expansion unit 160 is a recyclable and inflatable bag. For example, the first expansion unit 160 is a bag which is made of plastic material, and can be expanded corresponding to the shapes of the fifth electronic component 18 and the third electronic component 16.

Therefore, the first expansion unit 160 can have a larger first secondary sound cavity 1601, which can facilitate the speaker device 50R to achieve a better low-frequency sound output effect.

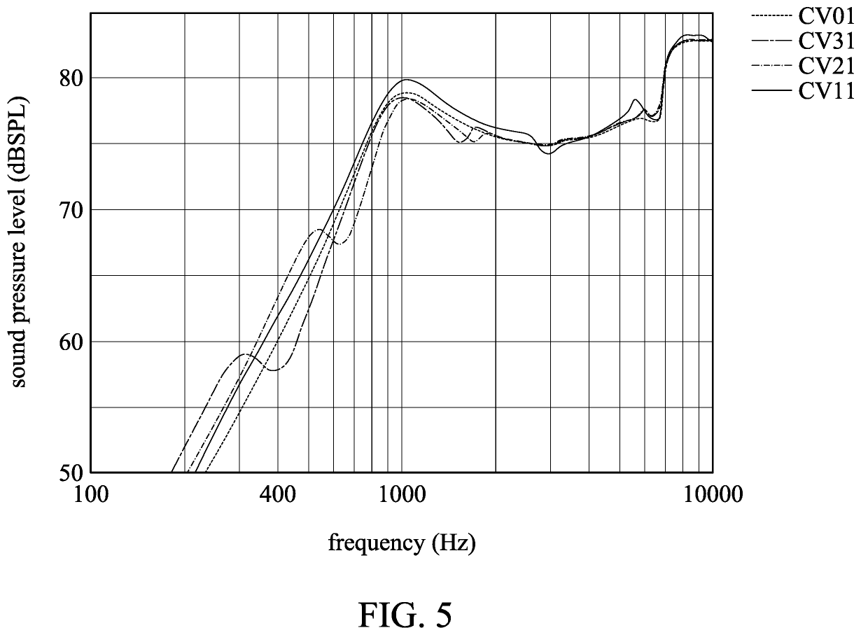

Next, please refer to FIG. 5, which is a chart illustrating the relationship between frequency and sound pressure level of the speaker devices of different embodiments of the present disclosure and a conventional speaker device. As shown in FIG. 5, the curve CV01 represents the sound pressure level curve of the conventional speaker device at different frequencies, and the curves CV11, CV21 and CV31 represent the sound pressure level curves of the speaker devices of the present disclosure at different frequencies.

The speaker device corresponding to the curve CV11 has a first loop tube 110 with a length of 50 mm and an internal diameter of 2 mm, the speaker device corresponding to the curve CV21 has a first loop tube 110 with a length of 100 mm and an internal diameter of 3.2 mm, and the first loop tube 110 is communicated with the first expansion unit 150 with an internal volume of 0.5 cc. Furthermore, the speaker device corresponding to the curve CV31 has a first loop tube 110 with a length of 100 mm and an internal diameter of 3.2 mm, and the first loop tube 110 is communicated with a first expansion unit 150 with an internal volume of 6.2 cc.

As shown in FIG. 5, in the frequency range of 400 Hz to 1000 Hz, the sound pressure level obtained by the speaker device of the present disclosure is higher than the sound pressure level obtained by the conventional speaker device, which means that the speaker device of the present disclosure can produce better sound output effect at low frequencies.

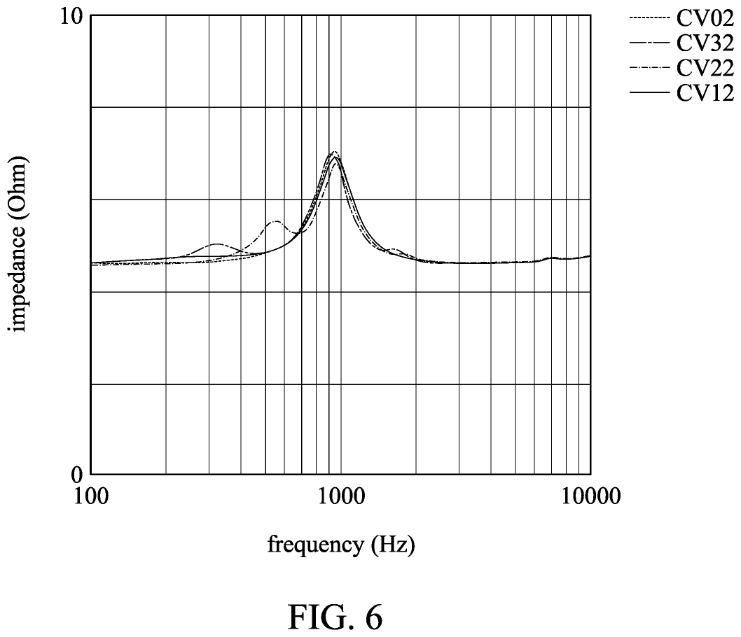

Please refer to FIG. 6. FIG. 6 is a chart illustrating the relationship between frequency and impedance of the speaker devices of different embodiments of the present disclosure and the conventional speaker device. As shown in FIG. 6, the curve CV02 represents the impedance curve of the conventional speaker device at different frequencies, and the curves CV12, CV22 and CV32 represent the impedance curves of the speaker devices of the present disclosure at different frequencies.

The curve CV12 and the curve CV11 correspond to the same speaker device, the curve CV22 and the curve CV21 correspond to the same speaker device, and the curve CV32 and the curve CV31 correspond to the same speaker device.

As shown in FIG. 6, in the frequency range of 400 Hz to 1000 Hz, the impedance of the speaker devices of the present disclosure is higher than the impedance of the conventional speaker device, which means that the speaker device of the present disclosure can produce better sound output effect at low frequencies.

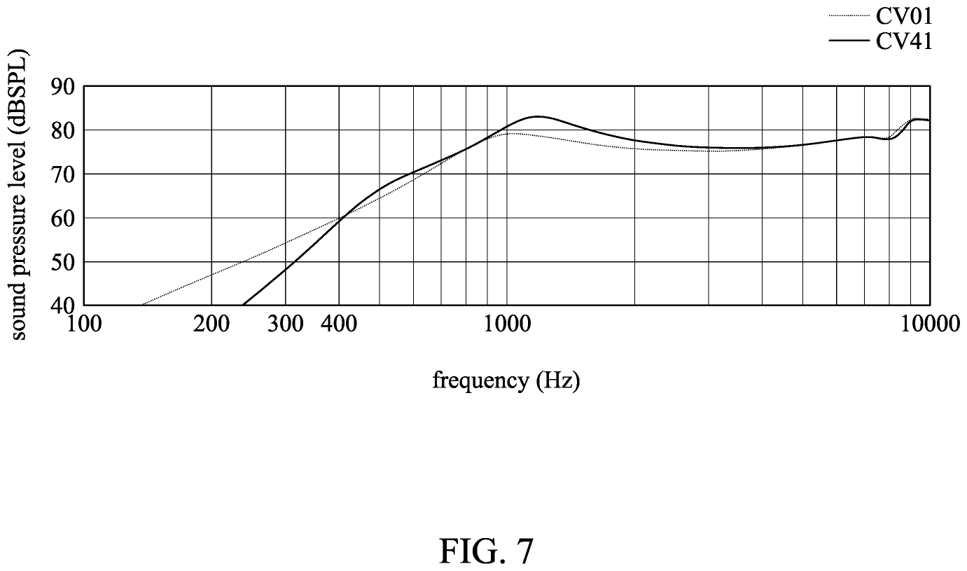

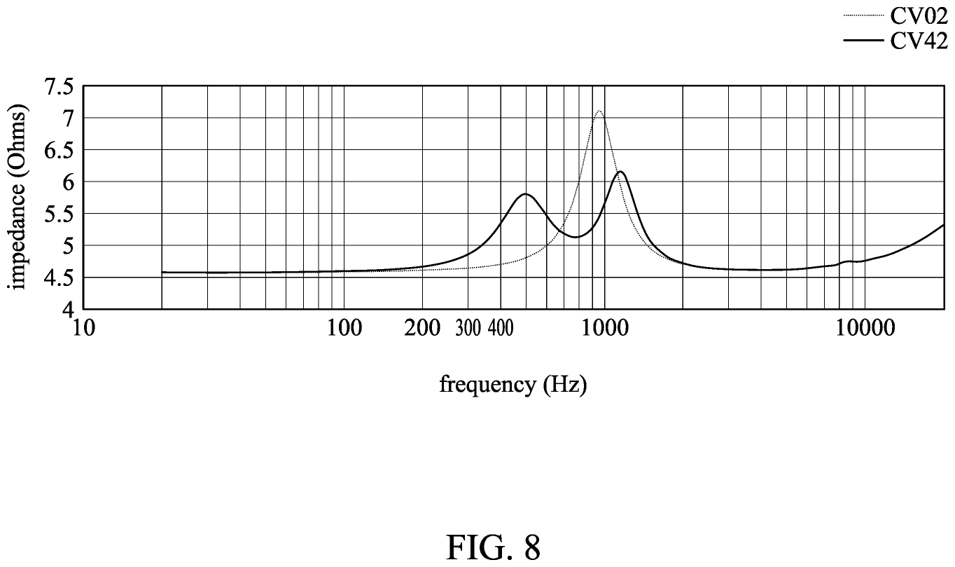

Please refer to FIG. 7 and FIG. 8. FIG. 7 is a chart illustrating the relationship between frequency and sound pressure level of the speaker device of another embodiment of the present disclosure and the conventional speaker device, and FIG. 8 is a chart illustrating the relationship between frequency and impedance of the speaker device of another embodiment of the present disclosure and the conventional speaker device.

The speaker device corresponding to the curve CV41 has the first loop tube 110 with a length of 10.5 mm and a cross-sectional area of 2*2 mm. It can be seen from FIG. 7 that in the frequency range of 400 Hz to 1000 Hz, as long as the length of the first loop tube 110 is greater than 10 mm, the sound pressure level obtained by the speaker devices of the present disclosure are all higher than the sound pressure level of the conventional speaker device, thereby producing better bass output.

It should be noted that in FIG. 7, although the sound pressure level of the curve CV41 in the range of 100 Hz to 400 Hz is smaller than the sound pressure level of the curve CV01, the sound in this frequency band can hardly be perceived by the human ear, so that it does not affect the low-frequency sound output effect of the speaker device of the present disclosure.

In FIG. 8, the curve CV42 and the curve CV41 correspond to the same speaker device. Similarly, it can be seen from FIG. 8 that the impedance of the speaker device of the present disclosure is higher than the impedance of the conventional speaker devices at low frequencies, which means that the speaker device of the present disclosure can produce better sound output effect at low frequencies.

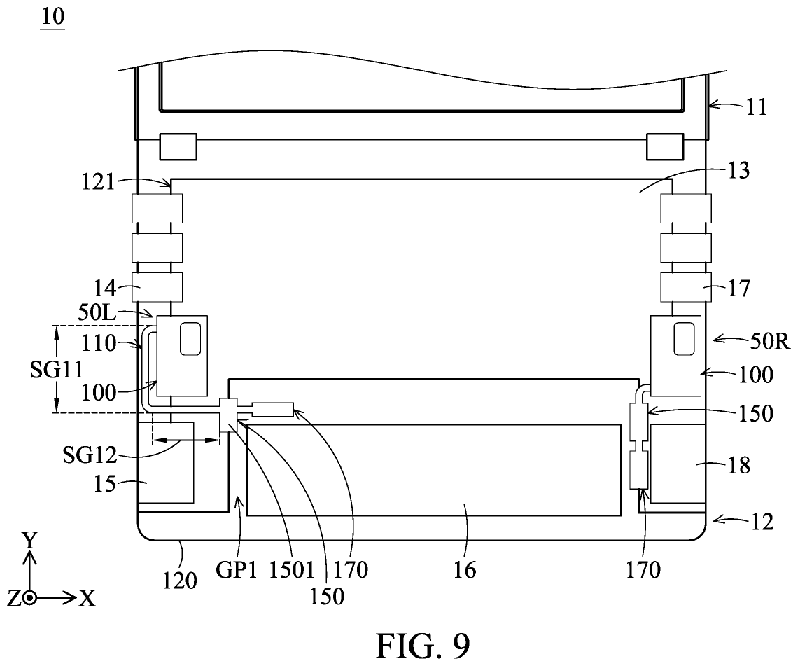

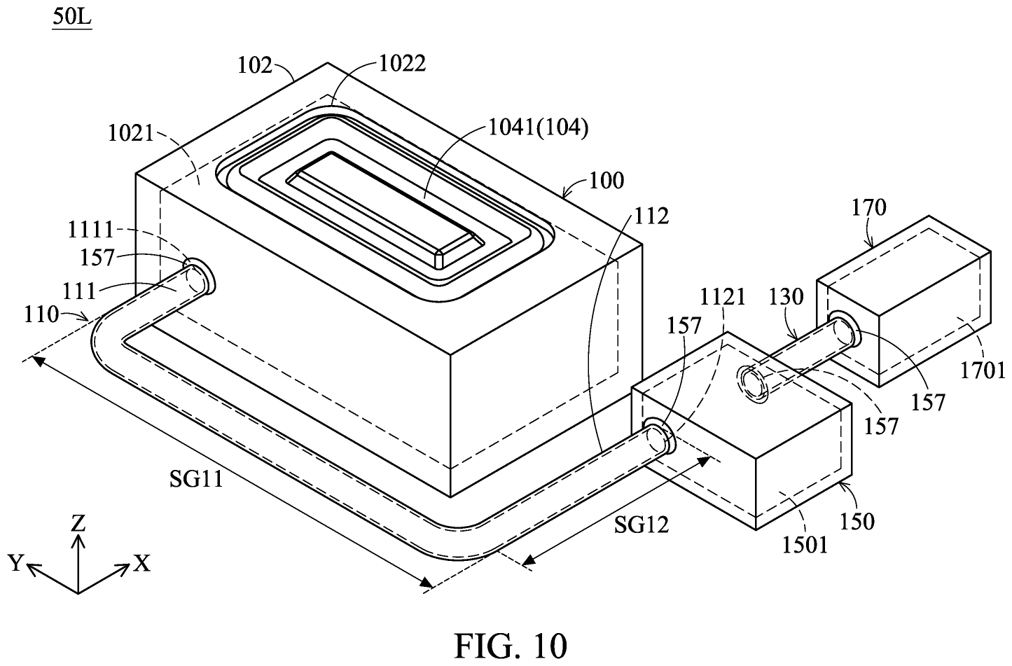

Next, please refer to FIG. 9 and FIG. 10. FIG. 9 is a schematic diagram of a partial structure of an electronic device 10 according to another embodiment of the present disclosure, and FIG. 10 is a schematic diagram of the speaker device 50L according to another embodiment of the present disclosure. In this embodiment, the speaker device 50L further includes a second loop tube 130 and a second expansion unit 170.

Specifically, the second loop tube 130 is connected between the first expansion unit 150 and the second expansion unit 170, so that a second secondary sound cavity 1701 formed by the second expansion unit 170 is communicated with the first secondary sound cavity 1501 and the main sound cavity 1021 via the second loop tube 130.

Similar to the first expansion unit 150, the second expansion unit 170 can be made of a metal material or an elastic plastic material, and the connecting junction of the second loop tube 130 and the second expansion unit 170 and the connecting junction of the second loop tube 130 and the first expansion unit 150 can be sealed by two sealing elements 157.

Because the closed second secondary sound cavity 1701 formed by the second expansion unit 170 can be communicated with the first secondary sound cavity 1501 and the main sound cavity 1021, the first secondary sound cavity 1501, the second secondary sound cavity 1701 and the main sound cavity 1021 can jointly form a larger sound cavity, so that it can improve the low-frequency sound output effect of the speaker device 50L.

In conclusion, the present disclosure provides a speaker device, including a speaker module 100 and a first loop tube 110. The first end 111 of the first loop tube 110 is connected to the casing 102 of the speaker module 100, the second end 112 of the first loop tube 110 is an unclosed free end which has a second opening 1121, so that the main sound cavity 1021 formed by the casing 102 is communicated with the outside air. Based on this design, the low-frequency sound output effect of the speaker device can be effectively improved.

In addition, in some embodiments, the speaker device may further include at least one expansion unit connected to the speaker module 100 through at least one loop tube. Because the secondary sound cavity formed by the expansion unit and the main sound cavity 1021 of the speaker module 100 can jointly form a larger sound cavity, the low-frequency sound output effect of the speaker device can be further improved.

Moreover, in some embodiments, an adjusting unit 200 can be disposed in the loop tube, and/or the expansion unit can be filled with porous material 155. Such design will reduce the moving speed of air molecules, so that the resonance frequency decreases correspondingly, thereby increasing the sound pressure level at low frequencies.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A speaker device installed in an electronic device, the speaker device comprising:
a speaker module, including:
a casing, having a main sound cavity and a sound outlet; and
a speaker unit, disposed in the casing, wherein the speaker unit includes
a diaphragm which is communicated with the sound outlet; and
a first loop tube, having a first end and a second end, wherein the first end is connected to the casing;
wherein a length of the first loop tube is at least 10 mm, and an internal diameter of the first loop tube is at least 2 mm.

2. The speaker device as claimed in claim 1, wherein the first end has a first opening which is communicated with the main sound cavity, and the second end has a second opening which is communicated with an accommodating space of the electronic device.

3. The speaker device as claimed in claim 2, wherein the casing has a rectangular structure, and the first loop tube has a first segment and a second segment, wherein the first end and the second end are respectively located in the first segment and the second segment, the first segment is parallel to and adjacent to a first side surface of the rectangular structure, and the second segment is parallel to and adjacent to a second side surface of the rectangular structure.

4. The speaker device as claimed in claim 2, wherein the speaker device further includes an adjusting unit disposed in the first loop tube, and the adjusting unit is disposed adjacent to the second opening.

5. The speaker device as claimed in claim 4, wherein a distance between the adjusting unit and the second opening is ten to twenty percent of a total length of the first loop tube.

6. The speaker device as claimed in claim 4, wherein the adjustment unit is made from of PU foam, PE foam, special rubber foam, melamine cotton, glass fiber cotton, rock wool, OFAN polyester fiber sound-absorbing cotton, melamine sound-absorbing cotton, activated carbon or a combination thereof.

7. The speaker device as claimed in claim 4, wherein the first loop tube is a tubular structure, and the adjusting unit is a cylindrical structure, wherein the adjusting unit conforms to the first loop tube.

8. The speaker device as claimed in claim 4, wherein the first loop tube is a rectangular tubular structure, the adjusting unit is correspondingly a rectangular columnar structure, and the cross-sections of the first loop tube and the adjusting unit are rectangles.

9. The speaker device as claimed in claim 1, wherein the speaker device further includes a first expansion unit corresponding to the shape of at least one internal component of the electronic device, the second end of the first loop tube is connected to the first expansion unit, and a first secondary sound cavity formed by the first expansion unit is communicated with the first loop tube and the main sound cavity via the second end.

10. The speaker device as claimed in claim 9, wherein the first expansion unit is made of metal.

11. The speaker device as claimed in claim 9, wherein the first secondary sound cavity is filled with a porous material which includes zeolite powder, activated carbon, or both.

12. The speaker device as claimed in claim 9, wherein a connecting junction of the first end and the casing is sealed by a sealing element, and a connecting junction of the second end and the first expansion unit is sealed by another sealing element, wherein the sealing elements include silicone or a sealing ring.

13. The speaker device as claimed in claim 9, wherein the first expansion unit is a recyclable and inflatable bag.

14. The speaker device as claimed in claim 9, wherein the speaker device further includes a second loop tube and a second expansion unit, the second loop tube is connected between the first expansion unit and the second expansion unit, so that a second secondary sound cavity formed by the second expansion unit is communicated with the first secondary sound cavity and the main sound cavity via the second loop tube.

15. The speaker device as claimed in claim 14, wherein a connecting junction of the second loop tube and the second expansion unit and a connecting junction of the second loop tube and the first expansion unit are sealed by two sealing elements.
